(19) United States
(12) Patent Application Publication
(10) Pub. No.: US 2018/0226045 A1
(43) Pub. Date: Aug. 9, 2018

(54) DISPLAY DEVICE AND DRIVING METHOD THEREOF

(71) Applicant: SAMSUNG DISPLAY CO., LTD., Yongin-si (KR)

(72) Inventors: Young Soo SOHN, Guri-si (KR); Min Je KIM, Suwon-si (KR); Jin Hyuk JANG, Hwaseong-si (KR)

(21) Appl. No.: 15/866,145

(22) Filed: Jan. 9, 2018

(30) Foreign Application Priority Data
Feb. 7, 2017 (KR) 10-2017-0016871

(51) Int. Cl. G09G 3/36; G02F 1/133

(52) U.S. Cl. CPC G09G 3/3688; G09G 3/3655; G09G 3/3607; G09G 2360/18; G02F 2203/30; G09G 2340/16; G02F 1/13306

(57) ABSTRACT

A display device includes: a data mapping portion including a memory having addresses corresponding to locations of pixels and which maps an input image signal to a corresponding address; a pattern detector which detects an image quality deterioration pattern in pattern detection areas from the mapped input image signal; a pattern counting portion which generates pattern information by counting the image quality deterioration pattern; a data analyzing portion which divides the input image signal for each frame and selects a representative value of an input image signal of a frame; and a controller which generates an image data signal based on a first inversion method or a second inversion method by determining whether the counted number of the image quality deterioration pattern exceeds a threshold value based on the pattern information, and determines a level of a common voltage corresponding to the representative value.

This application claims priority to Korean Patent Application No. 10-2017-0016871, filed on Feb. 7, 2017, and all the benefits accruing therefrom under 35 U.S.C. § 119, the content of which in its entirety is herein incorporated by reference.

### BACKGROUND

### (a) Field

Embodiments of the invention relate to a display device and a driving method thereof. More particularly, embodiments of the invention relate to a liquid crystal display and a driving method thereof.

### (b) Description of the Related Art

A liquid crystal display is one of the most widely used types of flat panel displays. The liquid crystal display typically includes a display panel where electrodes are provided, and a liquid crystal layer, and liquid crystal molecules in the liquid crystal layer is rearranged by generating an electric field by applying a voltage to the electrodes, and thus controls transmittance of light to display images.

### SUMMARY

In a liquid crystal display, coupling between a data line and a pixel electrode, coupling between a data line and a common electrode, a difference between a number of positive pixels and a number of negative pixels, and the like may cause problems such as crosstalk which causes vertical stripes of horizontal stripes to be seen, flicker of a screen, and the like, thereby causing deterioration of image quality. The deterioration of image quality may be more severe when a specific pattern is displayed.

Embodiments of the invention relate to a display device with improved image quality by preventing deterioration thereof which may occur in displaying of a specific pattern, and a method for driving the display device.

An exemplary embodiment of a display device includes: a data mapping portion including a memory having addresses respectively corresponding to locations of a plurality of pixels arranged in a matrix form, where the data mapping portion maps an input image signal to a corresponding address in the memory; a pattern detector which detects an image quality deterioration pattern in pattern detection areas, each of which corresponds to a predetermined number of pixels, from the mapped input image signal; a pattern counting portion which generates pattern information by counting the detected image quality deterioration pattern in the pattern detection areas; a data analyzing portion which divides the input image signal for each frame and selects a representative value of an input image signal of a frame; and a controller which generates an image data signal based on a first inversion method or a second inversion method by determining whether the counted number of the image quality deterioration patterns exceeds a threshold value based on the pattern information, and determines a level of a common voltage corresponding to the representative value.

In an exemplary embodiment, the display device may further include a plurality of data lines connected to the plurality of pixels, where the first inversion method may be a method in which adjacent data lines are applied with data voltages having opposite polarities, and the second inversion method may be a method in which a data voltage of a first polarity is applied to six adjacent data lines and a data voltage of a second polarity, which is different from the first polarity, is applied to other six adjacent data lines adjacent to the six adjacent data lines applied with the data voltage of the first polarity.

In an exemplary embodiment, the display device may further include a plurality of gate lines extending in a first direction along a plurality of pixel rows, respectively, and connected to the plurality of pixels, where the plurality of data lines may extend in a second direction along a plurality of pixel columns, respectively, in a way such that a plurality of pixels in each pixel column is connected to a corresponding data line at one side thereof.

In an exemplary embodiment, the display device may further include a plurality of gate lines extending in a first direction along a plurality of pixel rows, respectively, and connected to the plurality of pixels, wherein the plurality of data lines may extend in a second direction along a plurality of pixel columns and connected to the plurality of pixels, and a plurality of pixels connected to even-numbered gate lines may be connected to a data line adjacent to one side thereof, and a plurality of pixels connected to odd-numbered gate lines may be connected to a data line adjacent to the other side thereof.

In an exemplary embodiment, the controller may generate a first image data signal based on the first inversion method when the counted number of the image deterioration pattern is equal to or less than the threshold value, and may generate a second image data signal based on the second inversion method when the counted number of the image quality deterioration pattern exceeds the threshold value.

In an exemplary embodiment, the pattern detection area may include a first pattern detection area having a size of 1 row and 6 columns.

In an exemplary embodiment, the pattern detection area may include a second pattern detection area having a size of 2 rows and 3 columns.

In an exemplary embodiment, the data analyzing portion may divide gray ranges of the plurality of pixels into a predetermined number of count ranges, the data analyzing portion may select a count range where the greatest number of data is included by counting data included in each count range from an input image signal of the frame, and the data analyzing portion may select a representative gray representing the selected count range as a representative value of the frame.

In an exemplary embodiment, the controller may determine an average value of a positive data voltage of the representative gray and a negative data voltage of the representative gray as a common voltage corresponding to the representative value.

According to another exemplary embodiment of the invention, a method for driving a display device includes: mapping an input image signal to addresses corresponding to locations of a plurality of pixels arranged in a matrix form; detecting an image quality deterioration pattern per pattern detection area corresponding to a predetermined number of pixels from the mapped input image signal; counting the detected image quality deterioration pattern; determining whether or not the counted number of image quality deterioration patterns exceeds a threshold value; generating a second image data signal based on a second inversion method when the counted number of the image quality deterioration pattern exceeds the threshold value, and selecting a representative value of the input image signal; and displaying an image by applying a data voltage corresponding to the second image data signal and a common voltage corresponding to the representative value to the plurality of pixels.

In an exemplary embodiment, the second inversion method may be a method in which a data voltage of a first polarity is applied to six adjacent data lines and a data voltage of a second polarity, which is different from the first polarity, is applied to other six adjacent data lines adjacent to the six adjacent data lines applied with the data voltage of the first polarity.

In an exemplary embodiment, the pattern detection area may include a first pattern detection area having a size of 1 row and 6 columns.

In an exemplary embodiment, the pattern detection area may include a second pattern detection area having a size of 2 rows and 3 columns.

In an exemplary embodiment, the selecting the representative value of the input image signal may include dividing gray ranges of the plurality of pixels into a predetermined number of count ranges, selecting a count range where the greatest number of data is included by counting data included in each count range from the input image signals, and selecting a representative gray representing the selected count range as the representative value.

In an exemplary embodiment, the common voltage corresponding to the representative value may be an average value of a positive data voltage of the representative gray and a negative data voltage of the representative gray.

In an exemplary embodiment, the method for driving the display device may further include generating a first image data signal based on a first inversion method and displaying an image by applying a data voltage corresponding to the first image data signal to the plurality of pixels when the counted number of the image quality deterioration pattern is equal to or less than the threshold value.

According to still another exemplary embodiment of the invention, a display device includes: a plurality of pixels; a plurality of data lines connected to the plurality of pixels; a data driver which applies a data voltage of a first polarity to six adjacent data lines and applies a data voltage of a second polarity, which is different from the first polarity, to other six adjacent data lines adjacent to the six adjacent data lines applied with the data voltage of the first polarity; and a power supply which applies an output common voltage corresponding to an average value of a positive data voltage of a representative gray and a negative data voltage of the representative gray of an input image signal of one frame to the plurality of pixels.

In an exemplary embodiment, the data driver may be driven based on an inversion method in which data voltages having opposite polarities are applied to adjacent data lines.

In an exemplary embodiment, when the data driver is driven by the inversion method, the power supply may apply a predetermined reference common voltage to the plurality of pixels.

In an exemplary embodiment, the output common voltage may be different from the predetermined reference common voltage.

According to exemplary embodiments of the invention, the display device may prevent deterioration of image quality, which may occur in displaying of a specific pattern.

### BRIEF DESCRIPTION OF THE DRAWINGS

The above and other features of the invention will become more apparent by describing in further detail exemplary embodiments thereof with reference to the accompanying drawings, in which:

FIG. 1 is a schematic block diagram of a display device according to an exemplary embodiment of the invention;

FIG. 2 shows an exemplary embodiment of a pixel in the display device of FIG. 1;

FIG. 3 shows an exemplary embodiment of a display portion in the display device of FIG. 1;

FIG. 4 shows a an alternative exemplary embodiment of the display portion in the display device of FIG. 1;

FIG. 5 is a flowchart of a driving method of a display device, according to an exemplary embodiment of the invention;

FIG. 6 shows polarities of a plurality of pixels when an image quality deterioration pattern is displayed using a first inversion method;

FIG. 7 shows polarities of the plurality of pixels when the image quality deterioration pattern of FIG. 6 is displayed using a second inversion method;

FIG. 8 shows polarities of the plurality of pixels when another image deterioration pattern is displayed using the first inversion method;

FIG. 9 shows polarities of the plurality of pixels when the image quality deterioration pattern of FIG. 8 is displayed using the second inversion method;

FIG. 10 shows polarities of the plurality of pixels when another image deterioration pattern is displayed using the first inversion method;

FIG. 11 shows polarities of the plurality of pixels when the image quality deterioration pattern of FIG. 10 is displayed using the second inversion method;

FIG. 12 shows polarities of the plurality of pixels when another image deterioration pattern is displayed using the first inversion method;

FIG. 13 shows polarities of the plurality of pixels when the image quality deterioration pattern of FIG. 12 is displayed using the second inversion method; and

FIG. 14 is a graph provided for description of an exemplary method for selecting a representative value of an input image signal.

### DETAILED DESCRIPTION

The invention will be described more fully hereinafter with reference to the accompanying drawings, in which exemplary embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

In addition, the size and thickness of each configuration shown in the drawings are arbitrarily shown for better understanding and ease of description, but the invention is not limited thereto. In the drawings, the thickness of layers, films, panels, regions, etc., are exaggerated for clarity.

It will be understood that when an element such as a layer, film, region, or substrate is referred to as being “on” another element, it can be directly on the other element or intervening elements may also be present. In contrast, when an element is referred to as being “directly on” another element, there are no intervening elements present. The word “on” or “above” means positioned on or below the object portion, and does not necessarily mean positioned on the upper side of the object portion based on a gravitational direction.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Herein, the phrase “on a plane” means viewing a target portion from the top, and the phrase “on a cross-section” means viewing a cross-section formed by vertically cutting a target portion from the side.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Hereinafter, exemplary embodiments of the invention will be described in detail with reference to the accompanying drawings.

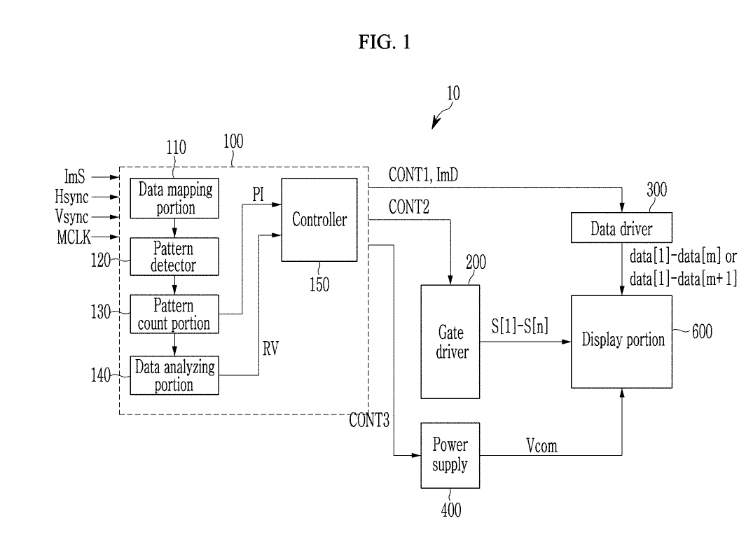

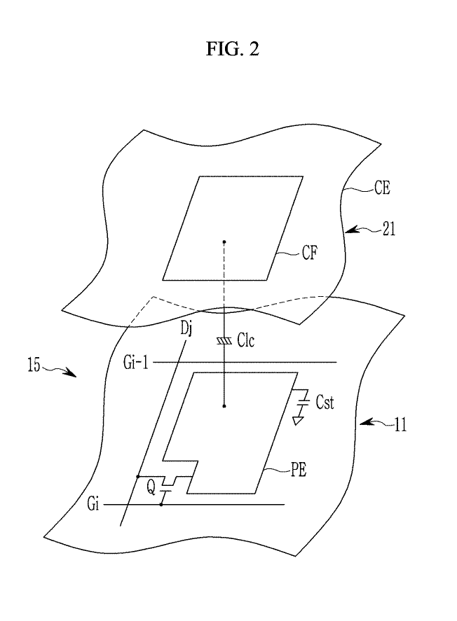

FIG. 1 is a schematic block diagram of a display device according to an exemplary embodiment of the invention. FIG. 2 shows an exemplary embodiment of a pixel in the display device of FIG. 1.

Referring to FIG. 1, an exemplary embodiment of a display device 10 includes a signal controller 100, a gate driver 200, a data driver 300, a power supply 400, and a display portion 600. In one exemplary embodiment, for example, the display device 10 may be a liquid crystal display (“LCD”), and may further include a backlight portion (not shown) that emits light toward the display portion 600.

The display portion 600 is a display area including a plurality of pixels. In an exemplary embodiment, a plurality of gate lines and a plurality of data lines are disposed in the display portion 600 and connected to the pixels. In such an embodiment, the gate lines extend substantially in a row direction and are substantially parallel with each other, and the data lines extend substantially in a column direction and are substantially parallel with each other. Each of the plurality of pixels may emit light of one of primary colors. The primary colors may include red, green and blue, and the three primary colors are spatially or temporally combined to obtain a desired color. A color may be displayed by a red pixel, a green pixel and a blue pixel, and the red pixel, the green pixel and the blue pixel may be collectively referred to as a unit pixel.

FIG. 2 illustrates an exemplary embodiment of a pixel in the display portion 600. In such an embodiment, the pixel includes a switch Q, a liquid crystal capacitor Clc, and a storage capacitor Cst. The liquid crystal capacitor Clc and the storage capacitor Cst are connected to the pixel.

The switch Q may be a three-terminal element such as a transistor and the like, provided in a first display panel 11. The switch Q includes a gate terminal connected to a corresponding gate line, e.g., an i-th gate line Gi, a first terminal connected to a corresponding data line, e.g., a j-th data line Dj, and a second terminal connected to the liquid crystal capacitor Clc and the storage capacitor Cst. Here, i and j are natural numbers.

The liquid crystal capacitor Clc includes a pixel electrode PE and a common electrode CE as two terminals thereof, and a liquid crystal layer 15 disposed between the pixel electrode PE and the common electrode CE serves as a dielectric material. The liquid crystal layer 15 has dielectric anisotropy. A pixel voltage is defined by a voltage difference between the pixel electrode PE and the common electrode CE.

The pixel electrode PE is connected to the switch Q, and thus receives a data voltage. The common electrode CE receives a common voltage. The common voltage may be about zero (0) volt (V) or another predetermined voltage. Here, a polarity of a data voltage is defined with reference to the common voltage. Here, a data voltage higher than the common voltage may be a data voltage having a positive value or a positive data voltage, and a data voltage lower than the common voltage may be a data voltage having a negative value or a negative data voltage.

The common electrode CE may be disposed throughout a second display panel 21 that faces the first display panel 11. In an alternative exemplary embodiment, the common electrode CE may be disposed in the first display panel 11, and in such an embodiment, at least one of two electrodes PE and CE may be in the shape of a line or a rod.

The storage capacitor Cst, which performs an auxiliary function of the liquid crystal capacitor Clc, is formed by an overlapping portion between an additional signal line (not shown) provided in the first display panel 11 and the pixel electrode PE while interposing an insulator therebetween.

A color filter CF may be disposed in the second display panel 21. Alternatively, the color filter CF may be disposed above or below the pixel electrode PE of the first display panel 11.

When a gate signal of a gate-on voltage is applied to the gate line Gi, a data voltage is applied to the data line Dj so that the data voltage is transmitted to the pixel electrode PE. Since the data voltage is charged to the pixel electrode PE, the pixel voltage may be defined by the voltage difference between the pixel electrode PE and the common electrode CE.

Referring back to FIG. 1, the signal controller 100 receives an input image signal ImS and a synchronization signal input from an external device. The input image signal ImS includes luminance information of a plurality of pixels. The luminance has a predetermined number of gray levels, for example, 1024 (=2¹⁰), 256 (=2⁸) or (64=2⁶). The synchronization signal includes a horizontal synchronization signal Hsync, a vertical synchronization signal Vsync, and a main clock signal MCLK.

The signal controller 100 generates a first driving control signal CONT1, a second driving control signal CONT2, a third driving control signal CONT3 and an image data signal ImD, based on the input image signal ImS, the horizontal synchronization signal Hsync, the vertical synchronization signal Vsync and the main clock signal MCLK.

The signal controller 100 divides the input image signal ImS by frame units based on the vertical synchronization signal Vsync, and divides the input image signal ImS by gate line units based on the horizontal synchronization signal Hsync to generate the image data signal ImD. The signal controller 100 transmits the image data signal ImD and the first driving control signal CONT1 to the data driver 300. The signal controller 100 transmits the second driving control signal CONT2 to the gate driver 200. The signal controller 100 transmits the third driving control signal CONT3 to the power supply 400.

In an exemplary embodiment, as shown in FIG. 1, the signal controller 100 may include a data mapping portion 110, a pattern detector 120, a pattern counting portion 130, a data analyzing portion 140, and a controller 150.

The data mapping portion 110 may include a memory that stores an address corresponding to a location of each of the plurality of pixels, and divides data of the input image signal ImS (hereinafter, input image data) into units respectively corresponding to the plurality of pixels (hereinafter, pixel units) and respectively stores the divided input image data in the corresponding addresses in the memory. Hereinafter, an operation, in which the data mapping portion 110 divides data of an input image signal into pixel units and stores the divided input image data in the corresponding addresses in the memory, will be referred to as mapping.

In one exemplary embodiment, for example, the data mapping portion 110 may perform mapping by dividing data of the input image signal ImS into frame units and gate line units. Accordingly, gray information or luminance information of each of the plurality of pixels may be aligned corresponding to an arrangement structure of the plurality of pixels per frame unit. The data mapping portion 110 transmits gray or luminance information of each of the plurality of pixels to the pattern detector 120.

The pattern detector 120 detects a predetermined image quality deterioration pattern from the mapped input image signal ImS. The image quality deterioration pattern implies an image pattern that is determined as causing undesired effects, such as crosstalk which causes vertical stripes or horizontal stripes to be seen, flicker of the screen, or an unintended color such as a reddish, greenish or bluish image. The image quality deterioration pattern may be predetermined through a manufacturing process or a test process depending on a feature of a display device. The image quality deterioration pattern may include a vertical stripe, a sub-vertical stripe, a checkerboard pattern, a sub-checkerboard pattern or the like, for example.

The pattern detector 120 may detect an image quality deterioration pattern by determining gray information or luminance information of each pixel per pattern detection area. The pattern detection area may include or defined by a predetermined number of pixels. In an exemplary embodiment, the pattern detector 120 may divide the display area into a plurality of pattern detection areas, and may detect whether or not an image quality deterioration pattern is included in each of the plurality of pattern detection areas. In such an embodiment, the pattern detector 120 may detect a type of image quality deterioration pattern by detecting an image quality deterioration pattern for each pattern detection area. The pattern detector 120 transmits, to the pattern counting portion 130, whether an image quality detection pattern is detected and a type of the image quality deterioration pattern for each pattern detection area.

In an exemplary embodiment, the pattern counting portion 130 counts the detected image quality deterioration patterns, thereby determining the number of the detected image quality deterioration patterns. In an alternative exemplary embodiment, the pattern counting portion 130 counts the pattern detection areas including the image quality deterioration pattern. The pattern counting portion 130 generates pattern information P that includes the counted number of the image quality deterioration patterns or the counted number of the pattern detection areas including the image quality deterioration pattern, and a type of the image quality deterioration pattern in each frame.

The data analyzing portion 140 divides the input image signal ImS into frame units, and selects a representative value RV of an input image signal ImS of one frame. The representative value RV of the input image signal ImS may be selected as the greatest number of gray or luminance levels among gray or luminance levels with respect to a plurality of pixels in one frame. The data analyzing portion 140 transmits the selected representative value (RV) to the controller 150.

The controller 150 determines whether or not the counted number of the image quality deterioration patterns exceeds a threshold value based on the pattern information PI, and generates an image data signal ImD using a first inversion method when the counted number of the image quality deterioration patterns is smaller than the threshold value, and generates an image data signal ImD using a second inversion method when the counted number of the image quality deterioration patterns is greater than the threshold value. When the first inversion method is used, data voltages of adjacent data lines have opposite polarities, and a polarity of a data voltage applied to a plurality of data lines is inverted per frame unit. When the second inversion method is used, a positive (or a negative) data voltage is applied to six adjacent data lines, a negative (or a positive) data voltage is applied to six other data lines that are adjacent to the six data lines where the positive (or negative) data voltage is applied, and a polarity of a data voltage applied to a plurality of data lines is inverted per frame unit.

When the image data signal ImD is generated using the second inversion method, the controller 150 may generate the third driving control signal CONT3 by determining a level of a common voltage Vcom based on the type of the image quality deterioration pattern and the representative value RV. The third driving control signal CONT3 may include information on the determined level of the common voltage Vcom.

The gate driver 200 is connected to a plurality of gate lines, and generates a plurality of gate signals S[1] to S[n] based on the second driving control signal CONT2. The gate driver 200 may sequentially apply the gate signals S[1] to S[n] having a gate-on voltage to the plurality of gate lines.

The data driver 300 is connected to a plurality of data lines, performs sampling and holding on the image data signal ImD based on the first driving control signal CONT1, and transmits a plurality of data voltages data[1]-data[m] to a plurality of data lines. The data driver 300 is synchronized with a time when the voltage level of the plurality of gate signals S[1] to S[n] respectively become the gate-on voltage, and thus applies the plurality of data voltages data[1] to data[m] or data[1] to data[m+1] corresponding to the image data signal ImD to the plurality of data lines. The data driver 300 may output the data voltages data[1] to data[m] or data[1] to data[m+1] using a method, in which data voltages of adjacent data lines have opposite polarities and polarities of data voltages applied to the plurality of data lines are inverted per frame unit, based on the image data signal ImD transmitted from the signal controller 100. In an alternative exemplary embodiment, the data driver 300 may apply a positive (or negative) data signal ImD to six adjacent data lines and apply a negative (or positive) data voltage to six other data lines that are adjacent to the six data lines where the positive (or negative) data voltage is applied, based on the image data signal ImD transmitted from the signal controller 100.

The power supply 400 generates the common voltage Vcom based on the third driving control signal CONT3, and transmits the common voltage Vcom to the display portion 600. The power supply 400 may adjust a voltage level of the common voltage Vcom based on the level information included in the third driving control signal CONT3. The power supply 400 may apply a predetermined reference common voltage to the plurality of pixels included in the display portion 600 in the first inversion method, and may apply a common voltage that corresponds to an average value of a positive data voltage of a representative gray and a negative data voltage of a representative gray of one frame in the second inversion method.

When the counted number of the image quality determination patterns exceeds the threshold value, the display device 10 generates an image data signal ImD using the second inversion method, and determines a common voltage Vcom based on a type of the image quality deterioration pattern and a representative value, to thereby effectively prevent image quality deterioration due to the image quality deterioration pattern.

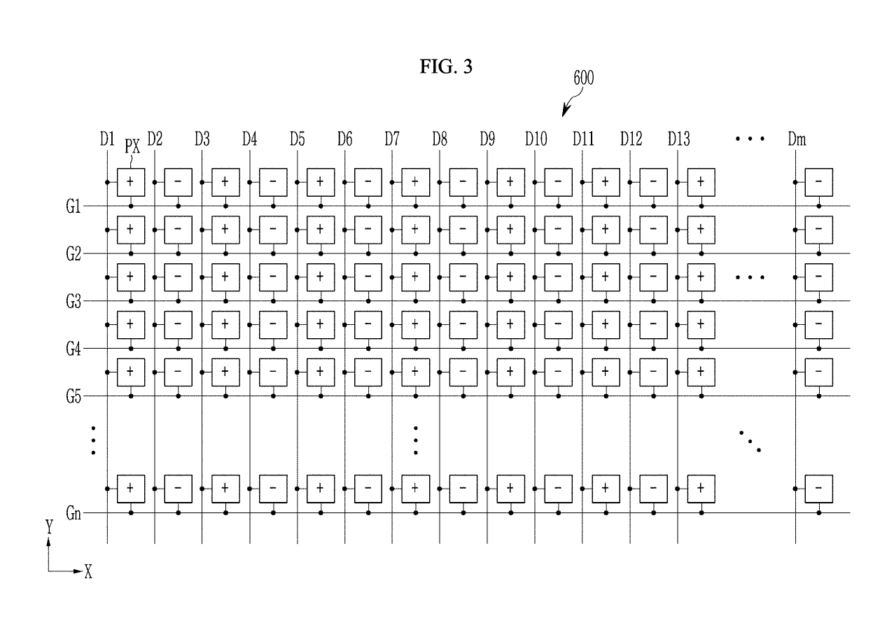

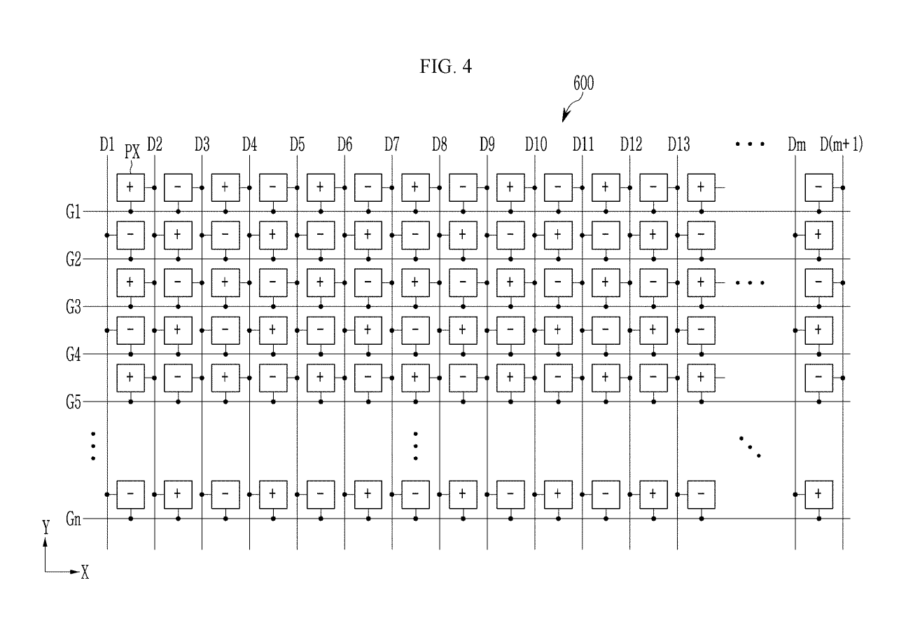

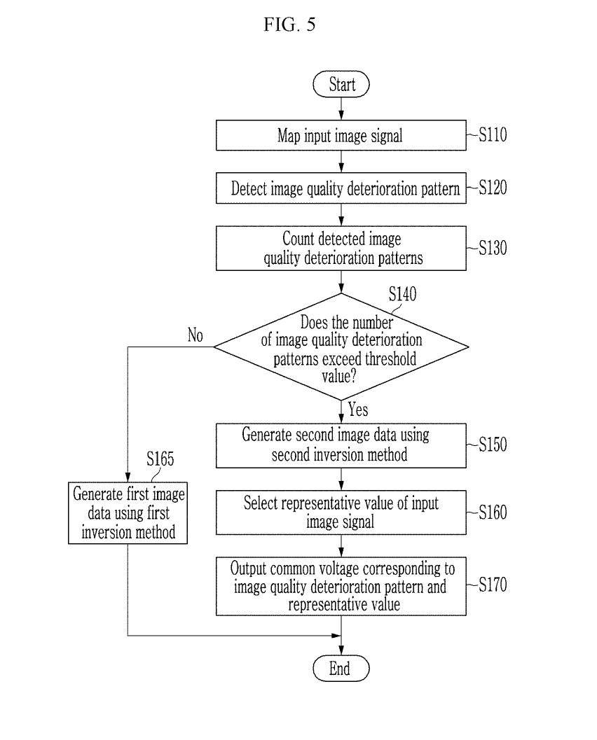

Hereinafter, referring to FIG. 3 and FIG. 4, an exemplary embodiment of a connection structure of the plurality of pixels included in the display portion 600 will be described, and referring to FIG. 5 to FIG. 14, an exemplary embodiment of a method for improving image quality in detection of a type of an image quality deterioration pattern and the image quality deterioration pattern will be described.

FIG. 3 shows an exemplary embodiment of the display portion in the display device of FIG. 1.

Referring to FIG. 3, a plurality of pixels PX are arranged in a matrix form, each of the plurality of gate lines G1 to Gn may extend in a first direction X along a pixel row and is thus connected to a plurality of pixels PX in the pixel row, and each of the plurality of data lines D1 to Dm may extend in a second direction Y along a pixel column and is thus connected to a plurality of pixels PX in the pixel column. The first direction X may be a row direction, and the second direction Y may be a column direction. A plurality of pixels PX in a same column may be connected to a data line that is adjacent at a same side (i.e., the left side of the pixel as shown in FIG. 3).

In an exemplary embodiment when the first inversion method is used, polarities of a plurality of data voltages applied to odd-numbered data lines D1, D3, D5, D7, D9, D11, D13, . . . and polarities of a plurality of data voltages applied to even-numbered data lines D2, D4, D6, D8, D10, D12, . . . , Dm may be opposite to each other in one frame. In the next frame, polarities of the plurality of data voltages applied to the plurality of data lines D1 to Dm are reversed to polarities of the previous frame.

In one exemplary embodiment, for example, as shown in FIG. 3, a plurality of positive data voltages may be applied to the odd-numbered data lines D1, D3, D5, D7, D9, D11, D13, . . . and a plurality of negative data voltages may be applied to the even-numbered data lines D2, D4, D6, D8, D10, D12, . . . , Dm in one frame. Accordingly, a plurality of pixels of odd-numbered pixel columns connected to the odd-numbered data lines D1, D3, D5, D7, D9, D11, D13, . . . are respectively charged with corresponding positive data voltages, and a plurality of pixels PX connected to even-numbered pixel columns connected to the even-numbered data lines D2, D4, D6, D8, D10, D12, . . . , Dm are respectively charged with corresponding negative data voltages.

In the next frame, negative data voltages may be applied to odd-numbered data lines D1, D3, D5, D7, D9, D11, D13, . . . , and positive data voltages may be applied to even-numbered data lines D2, D4, D6, D8, D10, D12, . . . , Dm. Accordingly, a plurality of pixels PX of odd-numbered pixel columns connected to the odd-numbered data lines D1, D3, D5, D7, D9, D11, D13, . . . may be charged with corresponding negative data voltages, and a plurality of pixels PX of even-numbered pixel columns connected to the even-numbered pixel columns may be charged with corresponding positive data voltages.

FIG. 4 shows an alternative exemplary embodiment of the display portion in the display device of FIG. 1.

Referring to FIG. 4, in an exemplary embodiment, a plurality of pixels PX are arranged in a matrix form, and each of a plurality of gate lines G1 to Gn extends in a first direction X along a corresponding pixel row and is thus connected to a plurality of pixels in the corresponding pixel row. In such an embodiment, as shown in FIG. 4, the number of a plurality of data lines D1 to D(m+1) is one more than the number of the pixel columns, and each of the plurality of data lines D1 to Dm, except for the last data line D(m+1), extends in the second direction Y while being adjacent to one side (i.e., the left side of the pixel as shown in FIG. 4) of each pixel per pixel column, and the last data line D(m+1) may extend in the second direction Y while being adjacent to the other side (i.e., the right side of the pixel as shown in FIG. 4).

Directions in which the plurality of pixels PX are connected to the data lines D1 to D(m+1) may be changed per unit of gate lines G1 to Gn or every pixel row. In an exemplary embodiment, as shown in FIG. 4, the plurality of pixels PX connected to the odd-numbered gate lines G1, G3, G5, . . . are connected to data lines that are adjacent to the other sides (i.e., the right sides of the respective pixels as shown in FIG. 4) of the respective pixels, and the plurality of pixels PX connected to the even-numbered gate lines of G2, G4, . . . , Gn are connected to data lines that are adjacent to one of sides (i.e., the left sides of the respective pixels as shown in FIG. 4) of the respective pixels. In an exemplary embodiment, when the first inversion method is used, polarities of data voltages applied to the odd-numbered data lines D1, D3, D5, D7, D9, D11, D13, . . . and polarities of data voltages applied to the even-numbered data lines D2, D4, D6, D8, D10, D12, . . . , Dm may be opposite to each other in one frame. In the next frame, polarities of data voltages applied to a plurality of data lines D1 to Dm are reversed.

In one exemplary embodiment, for example, as shown in FIG. 4, in one frame, negative data voltages may be applied to the odd-numbered data lines D1, D3, D5, D7, D9, D11, D13, . . . , and D(m+1) and positive data voltages may be applied to the even-numbered data lines D2, D4, D6, D8, D10, D12, . . . , and Dm. Accordingly, the plurality of pixels connected to the odd-numbered data lines D1, D3, D5, D7, D9, D11, D13, . . . , and D(m+1) are charged with negative data voltages, and the plurality of pixels PX connected to the even-numbered data lines D2, D4, D6, D8, D10, D12, . . . , and Dm may be charged with positive data voltages. In such an embodiment, each pixel PX is charged with a data voltage having a polarity that is different from polarities of data voltages charged to pixels PX adjacent in the first direction X and the second direction Y.

In the next frame, positive data voltages may be applied to the odd-numbered data lines D1, D3, D5, D7, D9, D11, D13, . . . , and D(m+1), and negative data voltages may be applied to the even-numbered data lines D2, D4, D6, D8, D10, D12, . . . , and Dm. Accordingly, the plurality of pixels PX connected to the odd-numbered data lines D1, D3, D5, D7, D9, D11, D13, . . . , and D(m+1) may be charged with positive data voltages, and the plurality of pixels PX connected to the even-numbered data lines D2, D4, D6, D8, D10, D12, . . . , and Dm may be charged with negative data voltages. In such an embodiment, each pixel is charged with a data voltage of which a polarity is different from polarities of data voltages applied to pixels that are adjacent in the first direction X and the second direction Y.

FIG. 5 is a flowchart of a driving method of the display device, according to an exemplary embodiment of the invention.

Referring to FIG. 1 to FIG. 5, in an exemplary embodiment, an input image signal is mapped (S110). In an exemplary embodiment, the data mapping portion 110 maps an input image signal ImS of one frame. In such an embodiment, the input image signal ImS is divided into pixel units and stored in the corresponding addresses in the memory.

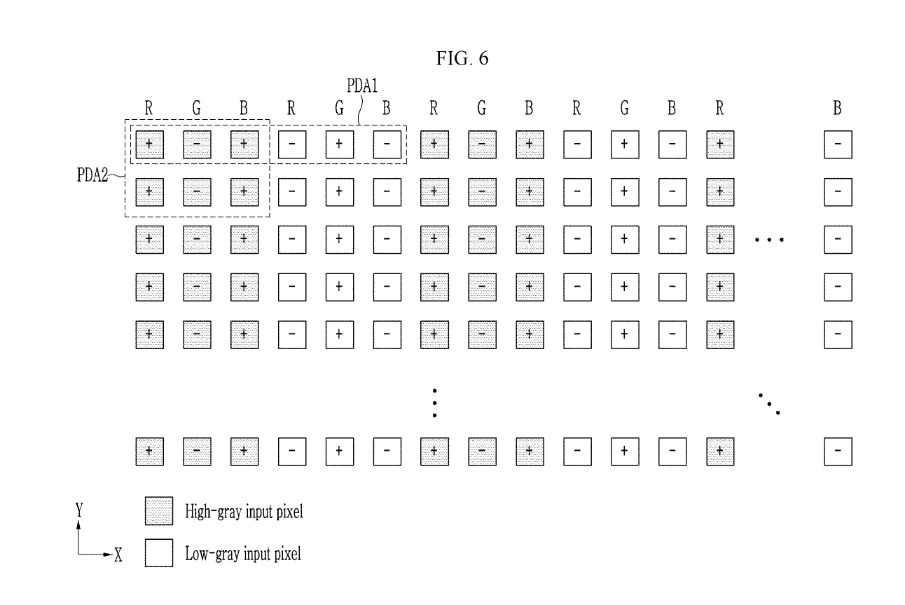

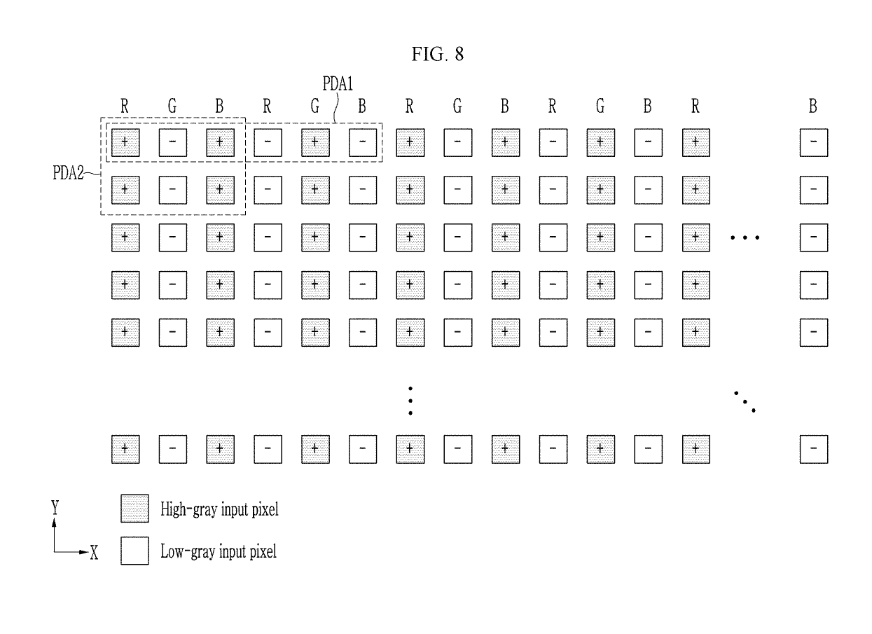

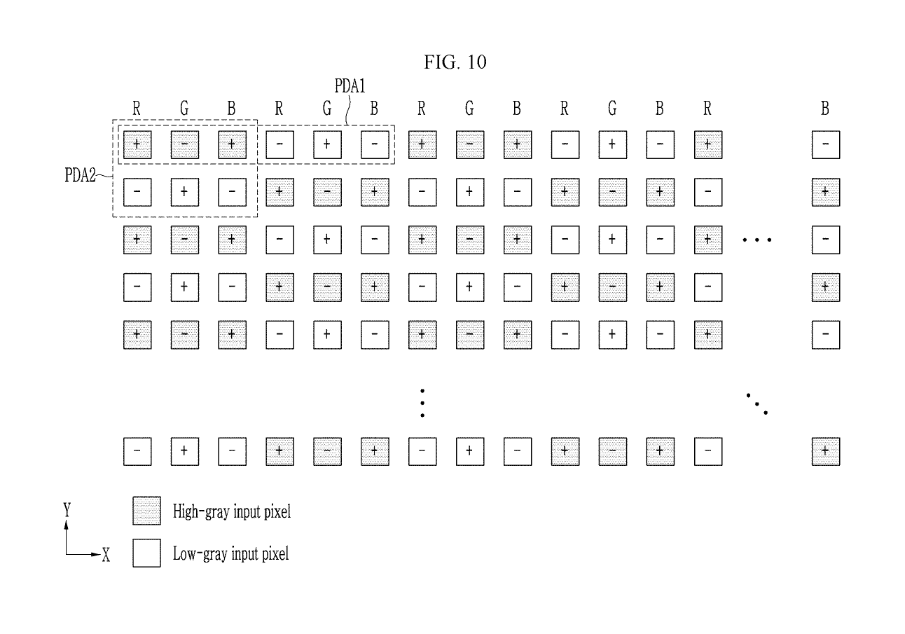

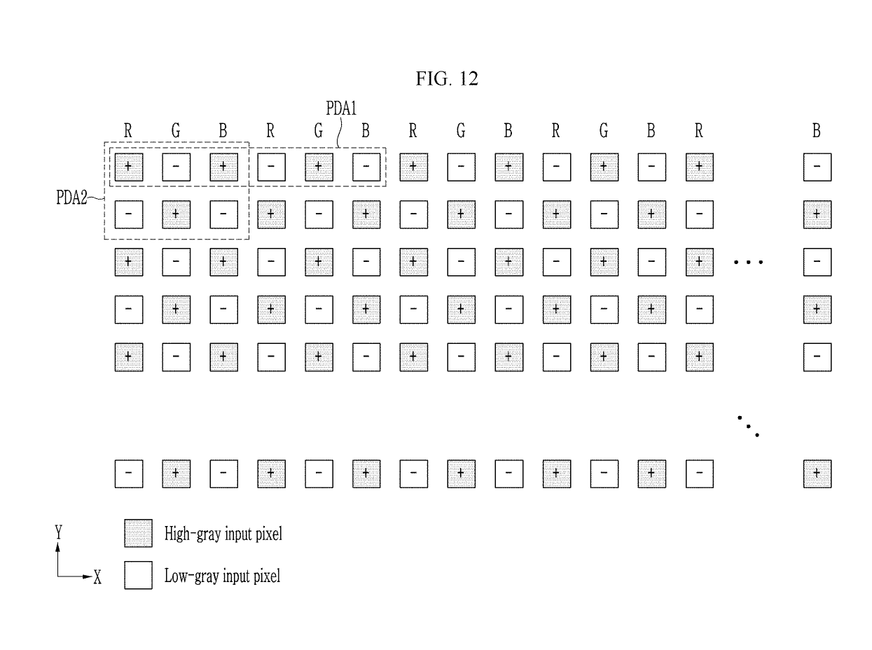

In such an embodiment, an image quality deterioration pattern is defected (S120). In an exemplary embodiment, the pattern detector 120 detects an image quality deterioration pattern. An image quality deterioration pattern may be predetermined in a manufacturing process or a test process depending on features of a display device. The image quality deterioration pattern may include a vertical stripe shown in FIG. 6, a sub-vertical stripe shown in FIG. 8, a checkerboard pattern shown in FIG. 10, a sub-checkerboard pattern shown in FIG. 12 and the like. However, types of the image quality deterioration pattern are not limited thereto.

First, referring to FIG. 6, a method for detecting an image quality deterioration pattern of a vertical stripe will be described. In FIG. 6, the plurality of data lines D1 to Dm and the plurality of gate lines G1 to Gn in the connection structure of the plurality of pixels PX and the plurality of data lines D1 to Dm in FIG. 3 are omitted for convenience of description.

FIG. 6 shows polarities of the plurality of pixels when an image quality deterioration pattern of a vertical stripe is displayed using the first inversion method.

Referring to FIG. 6, the plurality of pixels include red pixels R that displays a red color, green pixels G that displays a green color, and blue pixels PX that displays a blue color. The red pixels R, the green pixels G and the blue pixels B are alternately arranged in the first direction X, and pixels of a same color are arranged in the second direction Y.

In a vertical stripe pattern, a high-gray data voltage and a low-gray data voltage are alternatively applied at intervals of three data lines, and thus three columns of high-gray input pixels, where the high-gray data voltage is input, and three columns of low-gray input pixels, where the low-gray data voltage is input, are alternately disposed in the first direction X. The high-gray data voltage has a relatively high voltage difference with a common voltage Vcom, and the low-gray data voltage is a data voltage that is the same as or similar to the common voltage Vcom. The high-gray input pixel is a high-luminance pixel that displays a high luminance, and the low-gray input pixel is a low-luminance pixel that displays a low luminance. The three columns of high-gray input pixels may display a stripe pattern of an approximate white color in the second direction Y, and the three columns of low-gray input pixels may display a stripe pattern of an approximate black color in the second direction Y.

The pattern detector 120 determines gray information or luminance information per pattern detection area to thereby detect an image quality deterioration pattern.

As shown in FIG. 6, the pattern detector 120 may determine gray information or luminance information of the plurality of pixels per unit of a first pattern detection area PDA1 including six pixels arranged in a matrix of 1 row and 6 columns in the first direction X. The pattern detector 120 may detect an image quality deterioration pattern of a vertical stripe to exist when three consecutive high-gray input pixels and three consecutive low-gray input pixels are included in a single first pattern detection area PDA1. With such a method, the pattern detector 120 may detect whether or not an image quality deterioration pattern or a vertical stripe pattern is included in each of the plurality of first pattern detection areas PDA1.

Alternatively, the pattern detector 120 may detect gray information or luminance information of the plurality of pixels per a second pattern detection area PDA2 including pixels arranged in a matrix of 2 rows and 3 columns. The pattern detector 120 may detect existence of an image quality deterioration pattern of a vertical stripe when six high-gray input pixels or six low-gray input pixels are included in a single second pattern detection area PDA2 and six low-gray input pixels and six high-gray input pixels are included in another adjacent single second pattern detection area PDA2. With such a method, the pattern detector 120 may detect whether or not an image quality deterioration pattern or a vertical stripe pattern is included in each of the plurality of second pattern detection areas PDA2.

Next, referring to FIG. 8, a method for detecting an image quality deterioration pattern of a sub-vertical stripe will be described. In FIG. 8, the plurality of data lines D1 to Dm and the plurality of gate lines G1 to Gn in FIG. 3 in the connection structure of the plurality of pixels PX and the plurality of data lines D1 to Dm are omitted for convenience of description.

FIG. 8 shows polarities of the plurality of pixels when an image quality deterioration pattern of a sub-vertical stripe is displayed using the first inversion method.

Referring to FIG. 8, the plurality of pixels include red pixels R that display a red color, green pixels G that display a green color, and blue pixels PX that display a blue color. The red pixels R, the green pixels G and the blue pixels B are alternately arranged in the first direction X, and pixels of a same color are arranged in the second direction Y.

In the sub-vertical stripe pattern, a high-gray data voltage and a low-gray data voltage are alternatively applied for every one data line, and thus one column of high-gray input pixels where the high-gray data voltage is input and one column of low-gray input pixels where the low-gray data voltage is input are alternatively disposed in the first direction X.

As shown in FIG. 8, the pattern detector 120 may determine gray information or luminance information of the plurality of pixels per unit of the first pattern detection area PDA1. The pattern detector 120 may detect existence of an image quality deterioration pattern of a sub-vertical stripe when high-gray input pixels and low-gray input pixels are alternately disposed in one first pattern detection area PDA1. With such a method, the pattern detector 120 may detect whether or not an image quality deterioration pattern or a sub-vertical stripe pattern is included in each of the plurality of first pattern detection areas PDA1.

Alternatively, the pattern detector 120 may detect gray information or luminance information of the plurality of pixels per unit of the second pattern detection area PDA2. The pattern detector 120 may detect existence of an image quality deterioration pattern of the sub-vertical stripe in a second pattern detection area PDA2 when high-gray input pixels and low-gray input pixels are alternately arranged in the first direction X and the high-gray input pixels or the low-gray input pixels are consecutively arranged in the second direction Y in the second pattern detection area PDA2. With such a method, the pattern detector 120 may detect whether or not an image quality deterioration pattern or a sub-vertical stripe pattern is included in each of the plurality of second pattern detection areas PDA2.

Next, referring to FIG. 10, a method for detecting an image quality deterioration pattern of a checkerboard pattern will be described. In FIG. 10, the plurality of data lines D1 to D(m+1) and the plurality of gate lines G1 to Gn in the connection structure of the plurality of pixels PX and the plurality of data lines D1 to D(m+1) in FIG. 4 are omitted for convenience of illustration and description.

FIG. 10 shows polarities of the plurality of pixels when an image quality deterioration pattern of a checkerboard pattern is displayed using the first inversion method.

Referring to FIG. 10, the plurality of pixels include red pixels R that display a red color, green pixels G that display a green color, and blue pixels PX that display a blue color. The red pixels R, the green pixels G and the blue pixels B are alternately arranged in the first direction X, and pixels of a same color are arranged in the second direction Y.

In the checkerboard pattern, a high-gray data voltage and a low-gray data voltage are alternatively applied at intervals of three data lines, and thus three high-gray input pixels and three low-gray input pixels are alternately arranged in the first direction X while the high-gray input pixels and the low-gray input pixels are also alternately arranged per unit of the gate line in the second direction Y.

As shown in FIG. 10, the pattern detector 120 may determine gray information or luminance information of the plurality of pixels per unit of the first pattern detection area PDA1. The pattern detector 120 may detect existence of an image quality deterioration pattern of a checkerboard pattern when three consecutive high-gray input pixels and three consecutive low-gray input pixels are arranged in a single first pattern detection area PDA1 and three consecutive low-gray input pixels and three consecutive high-gray input pixels are arranged in another adjacent single first pattern detection area PDA1.

Alternatively, the pattern detector 120 may determine gray information or luminance information of the plurality of pixels per unit of the second pattern detection area PDA2. The pattern detector 120 may determine existence of an image quality deterioration pattern of the checkerboard when the high-gray input pixels are disposed in one row and the low-gray input pixels are disposed in another row in one second pattern detection area PDA2 and the low-gray input pixels are disposed in one row and the high-gray input pixels are disposed in another row in another second pattern detection area PDA2 that is adjacent in the second direction Y. With such a method, the pattern detector 120 may detect whether or not the image quality deterioration pattern or a checkerboard pattern is included in each of the plurality of second pattern detection areas PDA2.

Next, referring to FIG. 12, a method for detecting an image quality deterioration pattern of a sub-checkerboard pattern will be described. In FIG. 12, the plurality of data lines D1 to D(m+1) and the plurality of gate lines G1 to Gn in the connection structure of the plurality of pixels PX and the plurality of data lines D1 to D(m+1) in FIG. 4 are omitted for convenience of illustration and description.

FIG. 12 shows polarities of the plurality of pixels when another image quality deterioration pattern is displayed using the first inversion method.

Referring to FIG. 12, the plurality of pixels include red pixels R that display an image with a red color, green pixels G that display an image with a green color, and blue pixels PX that display an image with a blue color. The red pixels R, the green pixels G, and the blue pixels B are alternately arranged in the first direction X, and pixels of a same color are arranged in the second direction Y.

In the sub-checkerboard pattern, a high-gray data voltage and a low-gray data voltage are alternately applied for every data line so that the high-gray input pixels and the low-gray input pixels are alternately arranged in the first direction X and the second direction Y.

A shown in FIG. 12, the pattern detector 120 may determine gray information or luminance information of the plurality of pixels per unit of the first pattern detection area PDA1. The pattern detector 120 may detect existence of an image quality deterioration pattern of a sub-checkerboard when a high-gray input pixel and a low-gray input pixel are alternately arranged in a single first pattern detection area PDA1 and a low-gray input pixel and a high-gray input pixel are alternately arranged in another adjacent single first pattern detection area PDA1.

Alternatively, the pattern detector 120 may determine gray information or luminance information of the plurality of pixels per unit of the second pattern detection area PDA2. The pattern detector 120 may detect existence of the image quality deterioration pattern of the sub-checkerboard when high-gray input pixels and low-gray input pixels are alternately arranged in one row and low-gray input pixels and high-gray input pixels are alternately arranged in another row. With such a method, the pattern detector 120 may detect whether or not the image quality deterioration pattern or a sub-checkerboard pattern is included in each of the plurality of second pattern detection areas PDA2.

Referring back to FIG. 1 to FIG. 5, in an exemplary embodiment, the pattern detector 120 may notify existence of an image quality deterioration pattern to the pattern counting portion 130 whenever the image quality deterioration pattern is detected by using the first pattern detection area PDA1 or the second pattern detection area PDA2. In such an embodiment, the pattern detector 120 may transmit a type of the detected image quality deterioration pattern to the pattern counting portion 130.

As shown in FIG. 5, the detected image quality deterioration patterns are counted (S130). In an exemplary embodiment, the pattern counting portion 130 counts of the detected image quality deterioration patterns. The pattern counting portion 130 may count the image quality deterioration patterns per frame, and may transmit pattern information PI that includes the counted to number of the image quality deterioration patterns included in one frame and a type of the image quality deterioration pattern to the controller 150.

Whether the counted number of the image quality deterioration patterns exceeds a threshold value or not is determined (S140). In an exemplary embodiment, the controller 150 determines whether the counted number of the image quality deterioration patterns exceeds a threshold value based on the pattern information PI. The threshold value may be a predetermined value according to a type of an image quality deterioration pattern or a voltage used in the display device 10.

When the counted number of the image quality deterioration patterns is smaller than the threshold value, first image data is generated using the first inversion method (S165). In an exemplary embodiment, the controller 150 generates first image data using the first inversion method when the counted number of the image quality deterioration patterns is smaller than the threshold value. In such an embodiment, the data driver 300 may output data voltages data[1] to data[m] or data[1] to data[m+1] based on the first image data signal to apply data voltages of different polarities to the odd-numbered data lines and the even-numbered data lines respectively as shown in FIG. 3 and FIG. 4. Accordingly, the data voltage based on the first image data signal is applied to the plurality of pixels to display an image.

When the counted number of the image quality deterioration patterns exceeds the threshold value, a second image data signal is generated using a second inversion method (S150). In an exemplary embodiment, the controller 150 generates the second image data signal when the counted number of the image quality deterioration patterns exceeds the threshold value. In such an embodiment, a positive (or a negative) data voltage is applied to six adjacent data lines, a negative (or a positive) data voltage is applied to six other data lines that are adjacent to the six data lines where the positive (or negative) data voltage is applied, and a polarity of a data voltage applied to a plurality of data lines is inverted per frame unit. The data driver 300 outputs data voltages data[1] to data[m] or data[1] to data[m+1] using the second inversion method by the second image data signal.

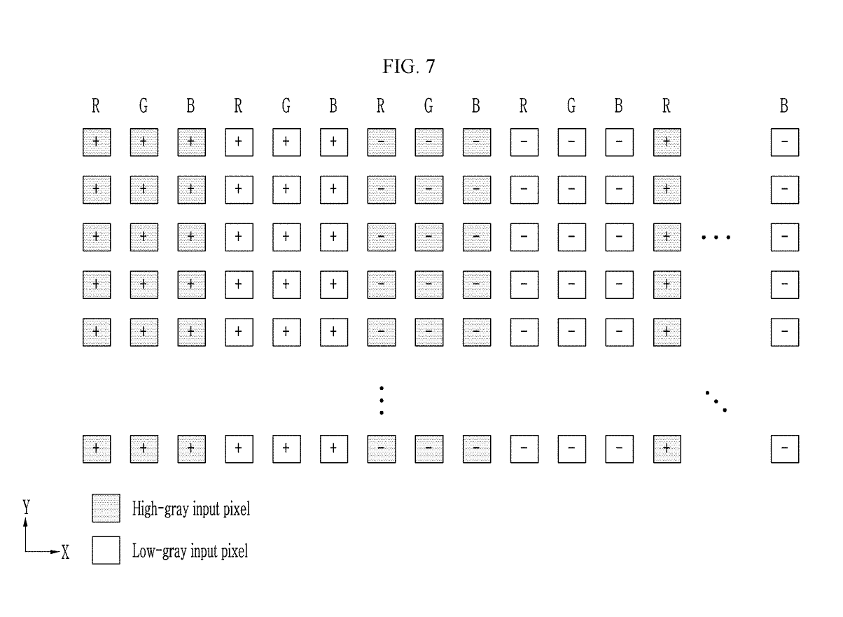

Referring to FIG. 7, a method for displaying the image quality deterioration pattern of the vertical stripe with a plurality of pixels using the second inversion method will be described. In FIG. 7, the plurality of data lines D1 to Dm and the plurality of gate lines G1 to Gn in the connection structure of the plurality of pixels PX and the plurality of data lines D1 to Dm in FIG. 3 are omitted for convenience of illustration and description.

FIG. 7 shows polarities of the plurality of pixels when the image quality deterioration pattern of FIG. 6 is displayed using the second inversion method.

Referring to FIG. 7, when the second inversion method is used to display the vertical stripe pattern, a positive data voltage is applied to six data lines and a negative data voltage is applied to six other data lines adjacent thereto in one frame. Accordingly, pixels of six columns are charged with a positive data voltage and pixels of six columns adjacent thereto are charged with a negative data voltage. That is, the pixels of the six columns charged to with the positive data voltage and the pixels of the six columns charged with the negative data voltage are alternately arranged in the first direction X.

Since the high-gray input pixels of three columns and the low-gray input pixels of three columns are alternatively arranged in the first direction in the vertical stripes, when the vertical stripe is displayed by using the second inversion method, the high-gray input pixels of three columns and low-gray input pixels of three columns are charged with a positive data voltage and high-gray input pixels of the next three columns and low-gray input pixels of the next three columns are charged with a negative data voltage.

The low-gray data voltage is the same as or similar to the common voltage Vcom, and therefore the common voltage Vcom is less influenced by coupling by the low-gray data voltage, and the high-gray data voltage has a high voltage difference with the common voltage Vcom. Accordingly, the common voltage Vcom may be greatly influenced by coupling by the low-gray data voltage.

When the vertical stripe is displayed by using the first inversion method as shown in FIG. 6, the number of pixels charged with a positive data voltage is greater than the number of pixels charged with a negative data voltage, among a plurality of high-gray input pixels, where a high-gray data voltage is input in one frame. Accordingly, the common voltage Vcom is more influenced by coupling by the positive data voltage than by coupling by the negative data voltage so that the common voltage may be changed to the positive data voltage side. When the vertical stripe is displayed by using the first inversion method, a voltage difference between the common voltage Vcom and the data voltage is reduced in the red pixel R and the blue pixel where the positive data voltage is applied, and the voltage difference between the common voltage Vcom and the data voltage may be increased in the green pixel G where the negative data voltage is applied. Accordingly, the image may become greenish, or a greenish defect may occur, due to increased luminance of the green pixels G.

When the vertical stripe is displayed by using the first inversion method, the polarity of the data voltage is reversed in the next frame, such that the red pixel R and the blue pixel B are applied with a negative data voltage and the green pixel G is applied with a positive data voltage and the voltage level of the common voltage Vcom may be changed or moved toward the negative data voltage side. Accordingly, the common voltage Vcom may be rippled.

In an exemplary embodiment, when the vertical stripe is displayed by using the second inversion method as shown in FIG. 7, the number of the pixels charged with a negative data voltage in a plurality of high-gray input pixels and the number of the pixels charged with a positive data voltage in the plurality of high-gray input pixels may be equal to each other regardless of a frame. Accordingly, coupling by the negative data voltage and coupling by the positive data voltage are equally applied to the common voltage Vcom so that the change of the common voltage Vcom may be minimized and a greenish detect and the like may be effectively prevented from occurring.

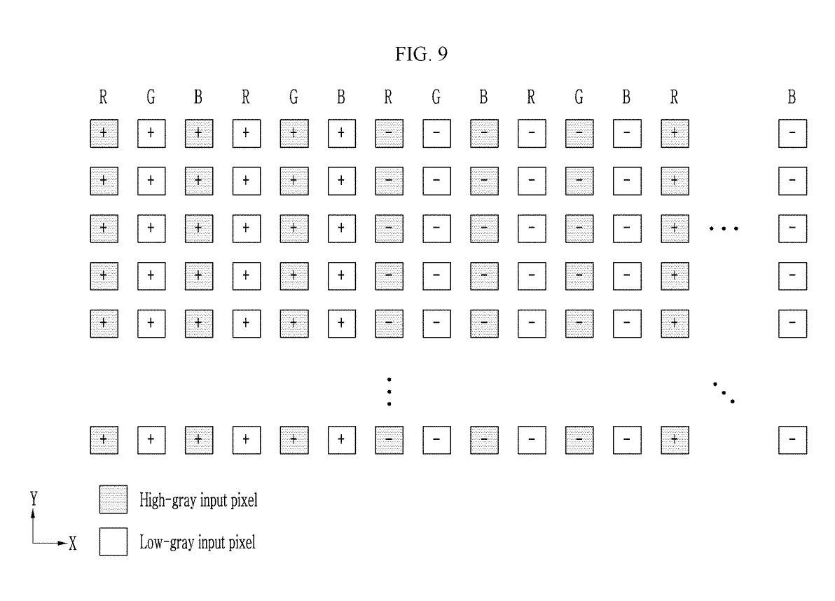

Next, referring to FIG. 9, a method for displaying the image quality deterioration pattern of the sub-vertical stripe with a plurality of pixels driven by the second inversion method will be described. In FIG. 9, the plurality of data lines D1 to Dm and the plurality of gate lines G1 to Gn in the connection structure of the plurality of pixels PX and the plurality of data lines D1 to Dm in FIG. 3 are omitted for convenience of illustration and description.

FIG. 9 shows polarities of the plurality of pixels when the image quality deterioration pattern of FIG. 8 is displayed using the second inversion method.

Referring to FIG. 9, when a sub-vertical stripe pattern where high-gray input pixels of one column and low-gray input pixels of one column are alternatively arranged is displayed by using the second inversion method, the high-gray input pixels of one column charged with a positive data voltage and the low-gray input pixels of one column charged with a negative data voltage are alternately arranged for six columns, and the high-gray input pixels of one column charged with the negative data voltage and the low-gray input pixels of one column charged with the negative data voltage are alternatively arranged in the next six columns.

When the sub-vertical stripe pattern is displayed using the first inversion method as shown in FIG. 8, the plurality of high-gray input pixels, to which the high-gray data voltage is input, are charged with a positive data voltage. Accordingly, the common voltage Vcom is greatly influenced by coupling by the positive data voltage so that the voltage level of the common voltage Vcom may be changed or moved to the positive data voltage side. An overall color of the image may be changed as the common voltage Vcom is changed, and particularly, a color of an overall image may be greatly changed when the sub-vertical stripe pattern and the general image are displayed together. When the sub-vertical stripe pattern is displayed using the first inversion method, a polarity of a data voltage is reversed in the next frame, such that the red pixel R and the blue pixel B are applied with a negative data voltage and the green pixel G is applied to the positive data voltage. Accordingly, the voltage level of the common voltage Vcom may be changed or moved to the negative data voltage side, such that the common voltage Vcom may be rippled.

In an exemplary embodiment, the sub-vertical stripe is displayed using the second inversion method as shown in FIG. 9, the number of the pixels charged with a negative data voltage and the number of the pixels charged with a positive data voltage, among a plurality of high-gray input pixels, may be the same as each other regardless of a frame. Accordingly, coupling by the negative data voltage and coupling by the positive data voltage are equally applied to the common voltage Vcom so that the change of the common voltage Vcom may be minimized and deterioration of image quality may be effectively prevented.

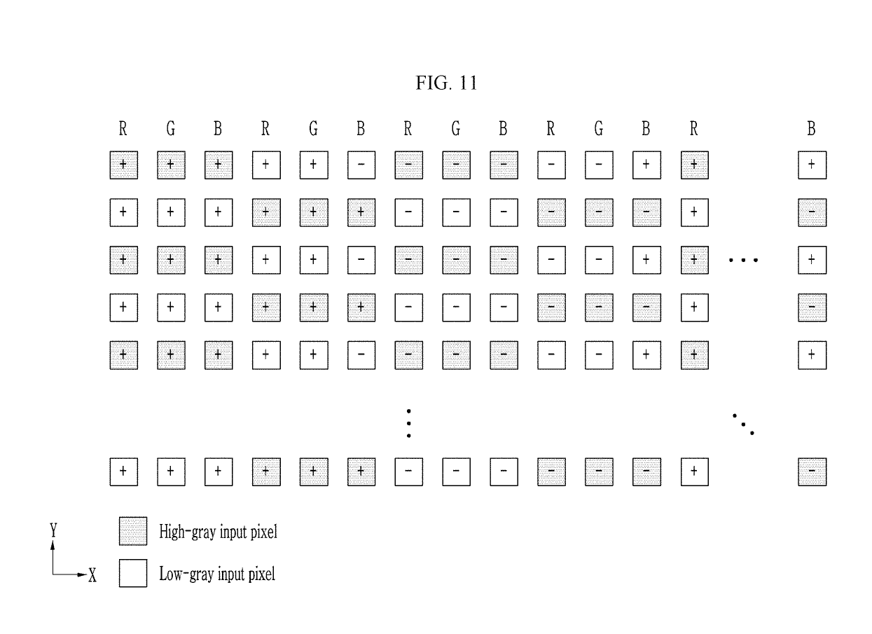

Next, referring to FIG. 11, a method for displaying the image quality deterioration pattern of a checkerboard with a plurality of pixels using the second inversion method will be described

In FIG. 11, the plurality of data lines D1 to Dm and the plurality of gate lines G1 to Gn in the connection structure of the plurality of pixels PX and the plurality of data lines D1 to Dm in FIG. 4 are omitted for convenience of illustration and description.

FIG. 11 shows polarities of the plurality of pixels when the image quality deterioration pattern of FIG. 10 is displayed using the second inversion method.

Referring to FIG. 11, when the checkerboard pattern is displayed using the second inversion method, a positive data voltage is applied to six adjacent data lines, a negative data voltage is applied to six other data lines that are adjacent to the six data lines where the positive data voltage is applied, and therefore, the number of the high-gray input pixels charged with a positive data voltage and the number of the high-gray input pixels charged with a negative data voltage become equal to each other regardless of a frame.

When the checkerboard pattern is displayed using the first inversion method as shown in FIG. 10, the number of the pixels charged with a positive data voltage is greater than the number of the pixels charged with a negative data voltage among the plurality of high-gray input pixels where a data voltage of a high gray is input, and therefore, the voltage level of the common voltage Vcom is changed or moved to the positive data voltage side by coupling such that the image may become greenish. In addition, when the polarities of the data voltages are reversed in the next frame, the voltage level of the common voltage Vcom may be changed or moved to a negative data voltage side by coupling. Accordingly, the common voltage Vcom may be rippled and image quality may be deteriorated.

In an exemplary embodiment, the checkerboard pattern is displayed using the second inversion method as shown in FIG. 11, the number of the high-gray input pixels charged with a positive data voltage and the number of the high-gray input pixels charged with a negative data voltage become equal to each other regardless of a frame, and therefore a change of the common voltage Vcom may be minimized and an image may be prevented from being greenish.

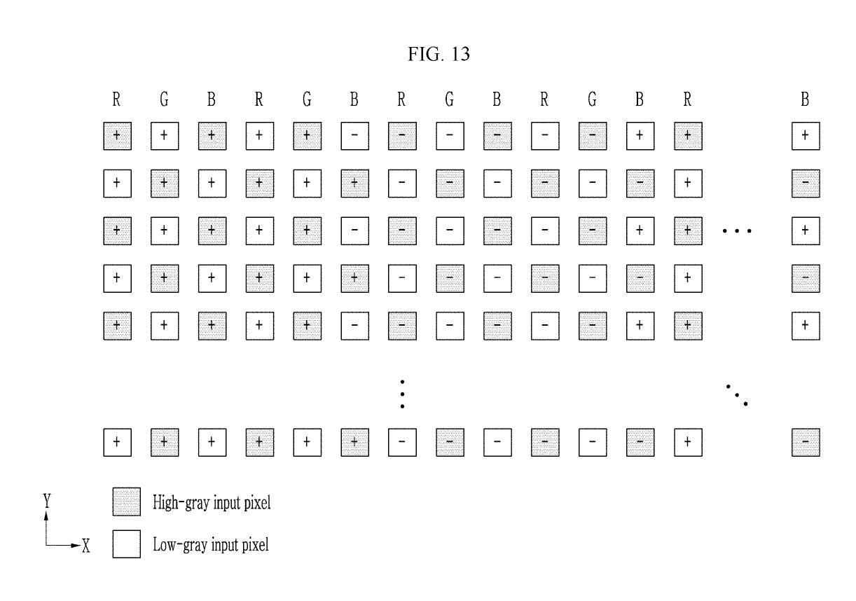

Next, referring to FIG. 13, a method for displaying an image quality deterioration pattern of a sub-checkerboard with a plurality of pixels driven by using the second inversion method will be described. In FIG. 13 the plurality of data lines D1 to Dm and the plurality of gate lines G1 to Gn in the connection structure of the plurality of pixels PX and the plurality of data lines D1 to Dm in FIG. 4 are omitted for convenience of illustration and description.

FIG. 13 shows polarities of the plurality of pixels when the image quality deterioration pattern of FIG. 12 is displayed using the second inversion method.

Referring to FIG. 13, when the sub-checkerboard pattern is displayed using the second inversion method, a positive data voltage is applied to six adjacent data lines, a negative data voltage is applied to six other data lines that are adjacent to the six data lines where the positive data voltage is applied, and therefore the number of the high-gray input pixels charged with a positive data voltage and the number of the high-gray input pixels charged with a negative data voltage become equal to each other regardless of a frame.

When the sub-checkerboard pattern is displayed using the first inversion method as shown in FIG. 12, the plurality of high-gray input pixels where a data voltage of a high gray is input are all charged with a positive data voltage in one frame so that the voltage level of the common voltage Vcom is changed or moved to the positive data voltage side by coupling, and the overall color of the image may be changed. When the sub-checkerboard pattern is displayed using the first inversion method, since the plurality of high-gray input pixels where a data voltage of a high gray is input are all charged with a negative data voltage in the next frame, the common voltage Vcom may be changed to the negative data voltage side by coupling. Accordingly, the common voltage Vcom may be rippled and image quality may be deteriorated.

In an exemplary embodiment, the sub-checkerboard pattern is displayed using the second inversion method as shown in FIG. 13, such that the number of the high-gray input pixels charged with the positive data voltage and the number of the high-gray input pixels charged with the negative data voltage become equal to each other regardless of a frame. Accordingly, the change of the common voltage Vcom may be minimized and deterioration of image quality may be effectively prevented.

In an exemplary embodiment, as described above, when an image quality deterioration pattern is detected, second image data are generated based on the second inversion method to display an image so that change of the common voltage may be minimized, and deterioration of an image, such as the overall color change and the like, may be prevented.

However, in such an embodiment, when an image, where an image quality deterioration pattern and a general image are overlapped, is displayed using the second inversion method, vertical lines may be viewed in the image because an optimal common voltage has a slight difference in every gray level. Such a difference of the optimal common voltage for every gray level is desired to be compensated.

Referring back to FIG. 1 to FIG. 5, a representative value of an input image signal is selected (S160). In an exemplary embodiment, the data analyzing portion 140 selects a representative value RV of an input image signal ImS in one frame. The representative value RV of the input image signal ImS may be selected with the greatest number of gray levels or luminance among the gray levels or luminance for a plurality of pixels in one frame. In one exemplary embodiment, for example, the data analyzing portion 140 divides a gray range with respect to a plurality of pixels into a predetermined number of count ranges, counts data included in each count range to select a count range where the greatest number of data is included, and may select a representative gray that represents the selected count range as a representative value RV of the corresponding frame.

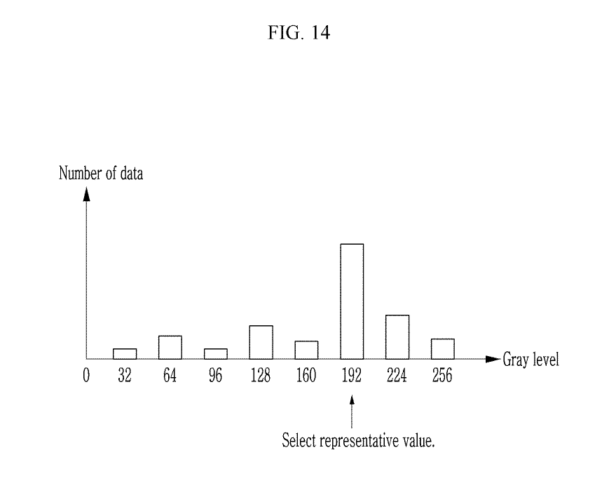

In an exemplary of the selecting the representative value RV, as shown in FIG. 14, when the input image signal ImS includes data of a gray level of 256 with respect to a plurality of pixels, the gray level of 256 is divided into eight count ranges and the counted number of data included in each of the eight count ranges is counted. In such an embodiment, the count ranges may have values that respectively represent the count ranges such as a gray level of 32, a gray level of 64, a gray level of 96, a gray level of 128, a gray level of 160, a gray level of 192, a gray level of 224, a gray level of 256, and the like. The gray level of 192 is a count range having the greatest counted number of data, among the respective count ranges, may be selected as a representative value of the corresponding frame.

The data analyzing portion 140 transmits the selected representative value VR to the controller 150, and generates a third driving control signal CONT3 by determining a level of a common voltage that corresponds to the image quality deterioration pattern and the representative value VR. A common voltage corresponding to the image quality deterioration pattern and the representative value RV is output (S170). The power supply 400 outputs a common voltage corresponding to the image quality deterioration pattern and the representative value RV to the display portion 600 in response to the third driving control signal CONT3 (S170). Accordingly, a data voltage according to the second image data signal and a common voltage corresponding to a representative value RV are applied to a plurality of pixels so than an image can be displayed.

A common voltage corresponding to an image quality deterioration pattern and a representative value RV satisfy the following Equation 1.

Vcom_ref=((Vdata_ref_pos+Vdata_ref_neg)/2)−Vkb_ref_gray

ΔVcom=(Vdata_pos+Vdata_neg)/2)−Vcom_ref

Vcom_out=Vcom_ref+ΔVcom (Equation 1)

Here, Vcom_ref denotes a reference common voltage, Vdata_ref_pos denotes a positive reference data voltage, Vdata_ref_neg denotes a negative reference data voltage, and Vkb_ref_gray denotes a kickback voltage per gray level. The reference common voltage Vcom_ref may be a predetermined to common voltage supplied to the display portion 600 by the power supply 400 in the first inversion method. Vdata_pos denotes a positive data voltage of a representative gray selected as the representative value RV, Vdata_neg denotes a negative data voltage of the representative gray selected as the representative value RV, and ΔVcom is a value acquired by subtracting the reference common voltage from an average value of the positive data voltage and the negative data voltage of the representative gray. Vcom_out denotes a common voltage corresponding to an image quality deterioration pattern and the representative value RV to be output to the display portion 600.

As in Equation 1, the common voltage Vcom_out output corresponding to the image quality deterioration pattern and the representative value RV becomes an average value of the positive data voltage Vdata_pos of the representative gray and the negative data voltage Vdata_neg of the representative gray. That is, Vcom_out=(Vdata_pos+Vdata_neg)/2.

Table 1 shows a result of an experiment of a common voltage Vcom_out output corresponding to an image quality deterioration pattern and a representative value RV. In the experiment, the reference common voltage Vcom_ref was set to 6.56 V.

TABLE 1

| | Vcom_out (V) | | | | |
|---|---|---|---|---|---|
| Representative gray | 32 | 64 | 128 | 192 | 255 |
| Vertical stripe | 6.74 | 6.69 | 6.63 | 6.59 | 6.56 |
| Sub-vertical stripe | 6.76 | 6.68 | 6.61 | 6.61 | 6.56 |
| Checkerboard | 6.73 | 6.69 | 6.64 | 6.64 | 6.56 |
| pattern | | | | | |
| Sub-checkerboard | 6.72 | 6.67 | 6.63 | 6.63 | 6.59 |
| pattern | | | | | |

As shown in Table 1, when the representative gray is a high gray level, the common voltage Vcom_out may be the same as the reference common voltage Vcom_ref, but when the representative gray becomes close to a low gray level, the common voltage Vcom_out may be different from the reference common voltage Vcom_ref.

In an exemplary embodiment, an undesired pattern such as a vertical stripe and the like is effectively prevented from being undesirably viewed in an image when the image including the image quality deterioration pattern is included is displayed using the second inversion method as the power supply 400 supplies a common voltage Vcom_out that is compensated corresponding to the image quality deterioration pattern and the representative value RV.

While the invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims. It will be understood by those skilled in the art that various changes in form and detail may be made without departing from the scope of the invention. Accordingly, the true scope of the invention should be determined by the technical idea of the appended claims.

What is claimed is:

1. A display device comprising:
a data mapping portion including a memory having addresses respectively corresponding to locations of a plurality of pixels arranged in a matrix form, wherein the data mapping portion maps an input image signal to a corresponding address in the memory;
a pattern detector which detects an image quality deterioration pattern in pattern detection areas, each of which corresponds to a predetermined number of pixels, from the mapped input image signal;
a pattern counting portion which generates pattern information by counting the detected image quality deterioration pattern in the pattern detection areas;
a data analyzing portion which divides the input image signal for each frame and selects a representative value of an input image signal of a frame; and
a controller which generates an image data signal based on a first inversion method or a second inversion method by determining whether the counted number of the image quality deterioration pattern exceeds a threshold value based on the pattern information, and determines a level of a common voltage corresponding to the representative value.

2. The display device of claim 1, further comprising:
a plurality of data lines connected to the plurality of pixels,
wherein
the first inversion method is a method in which adjacent data lines are applied with data voltages having opposite polarities to each other, and
the second inversion method is a method in which a data voltage of a first polarity is applied to six adjacent data lines and a data voltage of a second polarity, which is different from the first polarity, is applied to other six adjacent data lines adjacent to the six adjacent data lines applied with the data voltage of the first polarity.

3. The display device of claim 2, further comprising:
a plurality of gate lines extending in a first direction along a plurality of pixel rows, respectively, and connected to the plurality of pixels,
wherein the plurality of data lines extends in a second direction along a plurality of pixel columns, respectively, in a way such that a plurality of pixels in each pixel column is connected to a corresponding data line at one side thereof.

4. The display device of claim 2, further comprising:
a plurality of gate lines extending in a first direction along a plurality of pixel rows, respectively, and connected to the plurality of pixels,
wherein
the plurality of data lines extends in a second direction along a plurality of pixel columns and connected to the plurality of pixels,
a plurality of pixels connected to even-numbered gate lines is connected to a data line adjacent to one side thereof, and
a plurality of pixels connected to odd-numbered gate lines is connected to a data line adjacent to the other side thereof.

5. The display device of claim 2, wherein
the controller generates a first image data signal based on the first inversion method when the counted number of the image deterioration pattern is equal to or less than the threshold value, and
the controller generates a second image data signal based on the second inversion method when the counted number of the image quality deterioration pattern exceeds the threshold value.

6. The display device of claim 2, wherein the pattern detection area comprises a first pattern detection area having a size of 1 row and 6 columns.

7. The display device of claim 2, wherein the pattern detection area comprises a second pattern detection area having a size of 2 rows and 3 columns.

8. The display device of claim 1, wherein
the data analyzing portion divides gray ranges of the plurality of pixels into a predetermined number of count ranges,
the data analyzing portion selects a count range where the greatest number of data is included by counting data included in each count range from an input image signal of the frame, and
the data analyzing portion selects a representative gray, which represents the selected count range, as a representative value of the frame.

9. The display device of claim 6, wherein the controller determines an average value of a positive data voltage of the representative gray and a negative data voltage of the representative gray as a common voltage corresponding to the representative value.

10. A method for driving a display device, the method comprising:
mapping an input image signal to addresses corresponding to locations of a plurality of pixels, which are arranged in a matrix form;
detecting an image quality deterioration pattern per pattern detection area corresponding to a predetermined number of pixels from the mapped input image signal;
counting the detected image quality deterioration pattern;
determining whether or not the counted number of the image quality deterioration pattern exceeds a threshold value;
when the counted number of the image quality deterioration pattern exceeds the threshold value, generating a second image data signal based on a second inversion method, and selecting a representative value of the input image signal; and
displaying an image by applying a data voltage corresponding to the second image data signal and a common voltage corresponding to the representative value to the plurality of pixels.

11. The method for driving the display device of claim 10, wherein
the second inversion method is a method, in which a data voltage of a first polarity is applied to six adjacent data lines and a data voltage of a second polarity, which is different from the first polarity, is applied to other six adjacent data lines adjacent to the six adjacent data lines applied with the data voltage of the first polarity.

12. The method for driving the display device of claim 10, wherein the pattern detection area comprises a first pattern detection area having a size of 1 row and 6 columns.

13. The method for driving the display device of claim 10, wherein the pattern detection area comprises a second pattern detection area having a size of 2 rows and 3 columns.

14. The method for driving the display device of claim 10, wherein the selecting the representative value of the input image signal comprises:
dividing gray ranges of the plurality of pixels into a predetermined number of count ranges;
selecting a count range where the greatest number of data is included by counting data included in each count range from the input image signals; and
selecting a representative gray representing the selected count range as the representative value.

15. The method for driving the display device of claim 14, wherein the common voltage corresponding to the representative value is an average value of a positive data voltage of the representative gray and a negative data voltage of the representative gray.

16. The method for driving the display device of claim 10, further comprising:
when the counted number of image quality deterioration patterns is equal to or less than the threshold value, generating a first image data signal based on a first inversion method, and displaying an image by applying a data voltage corresponding to the first image data signal to the plurality of pixels.

17. A display device comprising:
a plurality of pixels;
a plurality of data lines connected to the plurality of pixels;
a data driver which applies a data voltage of a first polarity to six adjacent data lines and applies a data voltage of a second polarity, which is different from the first polarity, to other six adjacent data lines adjacent to the six adjacent data lines applied with the data voltage of the first polarity is applied; and
a power supply which applies an output common voltage corresponding to an average value of a positive data voltage of a representative gray and a negative data voltage of the representative gray of an input image signal of one frame to the plurality of pixels.

18. The display device of claim 17, wherein the data driver is driven by an inversion method in which data voltages having opposite polarities are applied to adjacent data lines.

19. The display device of claim 18, wherein when the data driver is driven by the inversion method, the power supply applies a predetermined reference common voltage to the plurality of pixels.

20. The display device of claim 19, wherein the output common voltage is different from the predetermined reference common voltage.
